(19) United States
(12) Patent Application Publication
(10) Pub. No.: US 2026/0288027 A1
(43) Pub. Date: Sep. 24, 2026

(54) TWO-COMPONENT DEVELOPER, DEVELOPER SET, DEVELOPING DEVICE, AND IMAGE FORMING APPARATUS

(71) Applicant: KYOCERA Document Solutions Inc., Osaka (JP)

(72) Inventors: Minoru WADA, Osaka (JP); Takeo MIZOBE, Osaka (JP); Yusuke KURANO, Osaka (JP)

(73) Assignee: KYOCERA Document Solutions Inc., Osaka (JP)

(21) Appl. No.: 19/570,864

(22) Filed: Mar. 18, 2026

(30) Foreign Application Priority Data
Mar. 24, 2025 (JP) 2025-048536

(51) Int. Cl. G03G 9/107; G03G 9/08; G03G 9/087; G03G 9/113; G03G 15/08

(52) U.S. Cl. CPC G03G 9/108; G03G 9/0823; G03G 9/08755; G03G 9/1136; G03G 9/1139; G03G 15/0812; G03G 15/0875; G03G 2215/068

(57) ABSTRACT

A two-component developer is used for developing an electrostatic latent image by a developing device, and contains toner and carrier. When a carrier resistance is R (Ω), and a saturation magnetization of the carrier is H (emu/g), then 14>log₁₀R>0.135H is satisfied.

### INCORPORATION BY REFERENCE

This application is based upon and claims the benefit of priority from the corresponding Japanese Patent Application No. 2025-048536 filed Mar. 24, 2025, the entire contents of which are hereby incorporated by reference.

### BACKGROUND

The present disclosure relates to a two-component developer, a developer set, a developing device, and an image forming apparatus.

An electrophotographic image forming apparatus includes a developing device. The developing device uses a two-component developer so as to develop an electrostatic latent image.

### SUMMARY

A two-component developer according to a first aspect of the present disclosure is used for developing an electrostatic latent image by a developing device. The two-component developer contains toner and carrier. When a carrier resistance is R (Ω), and a saturation magnetization of the carrier is H (emu/g), then 14>log₁₀R>0.135H is satisfied.

A developer set according to a second aspect of the present disclosure includes a first developer and a second developer. The first developer is stored in the developing device from beginning of use of the developing device. The second developer is stored in a replenishment container connected to the developing device, so as to be replenished to the developing device after starting use of the developing device. The first developer and the second developer are each the two-component developer described above. A contained amount of the carrier in the second developer in the replenishment container is 10 pts. mass or less with respect to 100 pts. mass of the toner.

A developing device according to a third aspect of the present disclosure is a developing device configured to develop an electrostatic latent image using the two-component developer described above. The developing device includes a developing roller and a regulating blade. The developing roller is supported in a rotatable manner and rotates while carrying the two-component developer on an outer peripheral surface, so as to convey the two-component developer on the outer peripheral surface to a development position, and to supply the toner to the electrostatic latent image at the development position. The regulating blade is made of a magnetic material and has a distal end at a position apart from the outer peripheral surface, on an upstream side of the development position in a rotation direction of the developing roller, so as to regulate a layer thickness of the two-component developer passing through between the outer peripheral surface and the distal end.

An image forming apparatus according to a fourth aspect of the present disclosure includes the developing device described above and a transfer unit. The transfer unit transfers an image developed by the developing device onto a sheet.

### BRIEF DESCRIPTION OF THE DRAWINGS

FIG. 1 is a schematic diagram of an image forming apparatus according to an embodiment.

FIG. 2 is a schematic diagram of a developing device and its vicinity according to the embodiment.

FIG. 3 is a schematic diagram of a developer according to the embodiment.

FIG. 4 is a schematic diagram for explaining a measurement method of a carrier resistance of the developer according to the embodiment.

FIG. 5 is a diagram illustrating a result of an experiment for checking effects of the embodiment.

### DETAILED DESCRIPTION

### <1. Image Forming Apparatus>

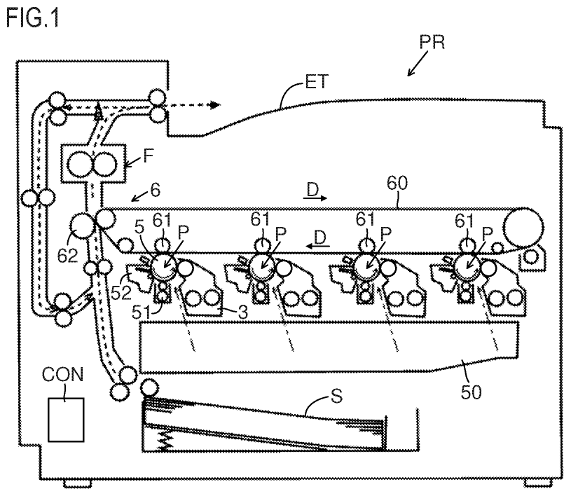

Hereinafter, with reference to FIG. 1, an image forming apparatus PR of this embodiment is described. The image forming apparatus PR is a printer.

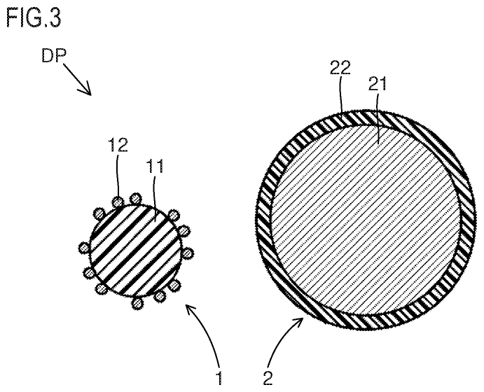

The image forming apparatus PR uses a developer set DS including the developer DP (see FIG. 3), so as to perform electrophotographic printing on a sheet S as a recording medium. The developer DP is a two-component developer, and it contains toner (an aggregate of toner particles 1) and carrier (an aggregate of carrier particles 2). The developer set DS is a set of the developer DP as an initial developer and the developer DP as a replenishment developer.

The image forming apparatus PR has a conveying path. In FIG. 1, the conveying path is shown by a broken line arrow. The image forming apparatus PR supplies the sheet S stored in a cassette to the conveying path, and conveys the sheet S along the conveying path. In this way, the sheet S passes through a transfer position and a fixing position in this order, and then it is discharged onto a discharge tray ET. At the transfer position, a transferring process is performed on the sheet S. At the fixing position, a fixing process is performed on the sheet S.

The image forming apparatus PR includes four image forming units P corresponding to four colors, i.e., cyan, magenta, yellow, and black colors. Each of the image forming units P forms an image using toner of the corresponding color. Hereinafter, one of the image forming units P is noted and a structure thereof is described. The image forming units P have the same basic structure. Therefore, descriptions of structures of other image forming units P are omitted by citing the following description.

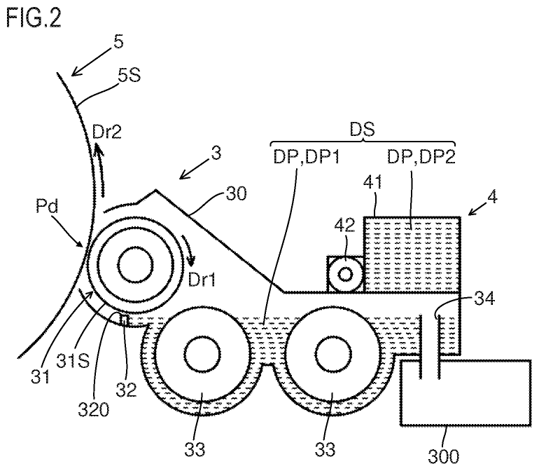

The image forming unit P includes developing device 3. The developing device 3 is connected to a replenishment unit 4 (see FIG. 2). In addition, the image forming unit P includes photosensitive drum 5. The photosensitive drum 5 constitutes one unit together with a charging device 51 and a cleaning device 52. Note that the image forming unit P includes an exposure device 50. The single exposure device 50 is shared by the image forming units P.

When the image forming unit P forms an image, the photosensitive drum 5 rotates. The charging device 51 charges the outer peripheral surface of the photosensitive drum 5. The exposure device 50 exposes the outer peripheral surface of the photosensitive drum 5, so as to form an electrostatic latent image on the outer peripheral surface of the photosensitive drum 5. The developing device 3 supplies toner to the electrostatic latent image on the outer peripheral surface of the photosensitive drum 5, so as to develop the electrostatic latent image into a toner image. The replenishment unit 4 replenishes the developer DP to the developing device 3. The cleaning device 52 removes residual toner on the outer peripheral surface of the photosensitive drum 5.

The image forming apparatus PR includes a transfer unit 6. The transfer unit 6 transfers the toner image on the outer peripheral surface of each photosensitive drum 5 to the sheet S. In other words, the transfer unit 6 transfers the images developed by the developing devices 3 to the sheet S.

The transfer unit 6 includes an intermediate transfer belt 60. The intermediate transfer belt 60 is an endless belt. The intermediate transfer belt 60 contacts the outer peripheral surfaces of the photosensitive drums 5, and in this state, it moves (rotates) in the direction shown by an arrow D.

The transfer unit 6 includes primary transfer rollers 61. There are a plurality of the primary transfer rollers 61 each of which is allotted to each of the cyan, magenta, yellow, and black colors. The primary transfer rollers 61 are disposed on an inner peripheral side of the intermediate transfer belt 60. Each of the primary transfer rollers 61 is disposed to face the photosensitive drum 5 carrying the toner image of the corresponding color, via the intermediate transfer belt 60 between them.

In addition, the image forming apparatus PR includes one secondary transfer roller 62. The secondary transfer roller 62 is pressed to contact the outer peripheral surface of the intermediate transfer belt 60 at the transfer position. A transfer nip is formed between the secondary transfer roller 62 and the intermediate transfer belt 60. In other words, the transfer nip is formed at the transfer position.

In a print job, the sheet S is conveyed to the transfer position (i.e., the transfer nip). The sheet S that is being conveyed passes through the transfer nip.

The intermediate transfer belt 60 receives primary transfer of toner images from the photosensitive drums 5. The intermediate transfer belt 60 rotates while carrying the toner images on the outer peripheral surface. When the sheet S is passing through the transfer nip, the sheet S contacts the outer peripheral surface of the intermediate transfer belt 60. In this way, the toner images are secondarily transferred to the sheet S that is passing through the transfer nip.

The image forming apparatus PR includes a fixing unit F. The fixing unit F includes a heating roller and a pressure roller. The heating roller includes a heater inside. The pressure roller is pressed to contact the heating roller. The heating roller and the pressure roller contact each other with pressure so as to form a fixing nip at the fixing position.

In the print job, the sheet S after the transferring process passes through the fixing nip. In other words, the sheet S is sandwiched between the heating roller and the pressure roller at the fixing nip. The fixing unit F heats the sheet S that is passing through the fixing nip. At the fixing nip, the sheet S is pressed. The fixing unit F heats and presses the sheet S after the transferring process, so as to fix the toner image to the sheet S. After the fixing process, the sheet S is discharged onto the discharge tray ET.

### <2. Developing Device>

Hereinafter, with reference to FIG. 2, the developing device 3 of this embodiment is described.

The developing device 3 uses the developer set DP so as to develop the electrostatic latent image. In other words, the developing device 3 uses the developer DP so as to develop the electrostatic latent image. A development method of the developing device 3 is a trickle development method. The developing device 3 receives replenishment of the developer DP from the replenishment unit 4. In other words, the image forming apparatus PR includes the replenishment units 4 in addition to the developing devices 3. The replenishment unit 4 may be one component of the developing device 3.

The developing device 3 includes a development casing 30. The developer DP is stored in the development casing 30 in advance. The developing device 3 uses the developer DP stored in the development casing 30 so as to perform development. In the following description, the developer DP stored in the development casing 30 is referred to as “developer currently in use”.

The developing device 3 includes a developing roller 31. The developing roller 31 has an outer peripheral surface 31S as a developer carrying surface. In the following description, the outer peripheral surface 31S of the developing roller 31 is referred to as the developer carrying surface 31S.

The developing roller 31 is disposed inside the development casing 30 and is supported in a rotatable manner. The developer carrying surface 31S of the developing roller 31 is partially exposed from inside to outside of the development casing 30. Specifically, the development casing 30 has an opening at a position facing the outer peripheral surface of the photosensitive drum 5 (here, denoted by 5S and referred to as a drum outer peripheral surface 5S). From this opening, the developer carrying surface 31S is partially exposed to the outside. In this way, the developer carrying surface 31S and the drum outer peripheral surface 5S face each other. The developer carrying surface 31S faces the drum outer peripheral surface 5S at a development position Pd with a predetermined space between them. In other words, development position Pd is a position at which the developer carrying surface 31S and the drum outer peripheral surface 5S face each other with a predetermined space between them.

The developing roller 31 rotates while carrying the developer currently in use on the developer carrying surface 31S, so as to convey the developer currently in use to the development position Pd on the developer carrying surface 31S. Then, the developing roller 31 supplies the toner in the developer currently in use on the developer carrying surface 31S, to the electrostatic latent image on the drum outer peripheral surface 5S at the development position Pd. In this case, the developing roller 31 and the photosensitive drum 5 each rotate. In FIG. 2, the rotation direction of the developing roller 31 is shown by an arrow Dr1, and the rotation direction of the photosensitive drum 5 is shown by an arrow Dr2.

The developing roller 31 includes a sleeve and a magnet roller. The sleeve is supported in a rotatable manner. An outer peripheral surface of the sleeve carries the developer currently in use. In other words, the developing roller 31 has the outer peripheral surface of the sleeve as the developer carrying surface 31S. The magnet roller is disposed inside the sleeve (inside the cylinder thereof). The magnet roller is supported in a manner unable to rotate. The magnet roller has a plurality of magnetic poles in the circumferential direction. The sleeve can rotate about an axis of the magnet roller.

The developing device 3 includes a regulating blade 32. The regulating blade 32 is made of a magnetic material. Although not limited in particular, a stainless steel or the like can be used as a constitutional material of the regulating blade 32.

The regulating blade 32 is attached to the development casing 30. The regulating blade 32 has a distal end 320 disposed close to the developer carrying surface 31S. The regulating blade 32 has the distal end 320 at a position apart from the developer carrying surface 31S, on an upstream side of the development position Pd in the rotation direction of the developing roller 31. The regulating blade 32 regulates a layer thickness of the developer currently in use, which passes through between the distal end 320 and the developer carrying surface 31S.

The developing device 3 includes two stirring screws 33. Each of the stirring screws 33 is disposed inside the development casing 30 and is supported in a rotatable manner. Each of the stirring screws 33 has a structure in which a helical blade is disposed on a rotation shaft. Each of the stirring screws 33 rotates so as to stir and convey the developer currently in use, while the toner in the developer currently in use is charged.

During rotation of the developing roller 31, the developer currently in use (specifically, the carrier carrying the toner) is attracted to the developer carrying surface 31S by a magnetic force of the magnet roller, and a magnetic brush containing the toner and the carrier of the developer currently in use is formed on the developer carrying surface 31S. Then, when the magnetic brush passes through a gap formed between the developer carrying surface 31S and the distal end 320 of the regulating blade 32 (hereinafter, referred to as a regulation gap), the magnetic brush is regulated to have a constant layer thickness. Note that when the developer currently in use (magnetic brush) passes through the regulation gap, a stress is exerted on the developer currently in use.

In addition, a development voltage is applied to the developing roller 31. In this way, a potential difference is generated between the developing roller 31 and the photosensitive drum 5. This potential difference allows the toner in the magnetic brush to move from the developing roller 31 to the photosensitive drum 5. In other words, the toner moves to the electrostatic latent image on the outer peripheral surface 5S of the photosensitive drum 5 (a part whose potential is decreased by exposure). As a result, the electrostatic latent image on the drum outer peripheral surface 5S is developed into the toner image.

The developing device 3 has a discharge path 34. The discharge path 34 connects the inside of the development casing 30 and a collection box 300. In this way, excess developer currently in use flows into the discharge path 34, moves along the discharge path 34, and reaches the collection box 300. In other words, excess developer currently in use is stored in the collection box 300.

The replenishment unit 4 includes a container 41 and a replenishment member 42. The container 41 corresponds to a “replenishment container”. The container 41 stores the developer DP. The replenishment member 42 replenishes the developer DP stored in the container 41 to the developing device 3. For instance, the replenishment member 42 includes a screw shaft. When the screw shaft rotates, the developer DP is replenished from the container 41 into the development casing 30.

The developer DP is used as the initial developer, and is also used as the replenishment developer. In other words, the initial developer and the replenishment developer are each the developer DP. In the following description, the developer DP as the initial developer is denoted by DP1 so that the developer DP is referred to as the initial developer DP1. In addition, the developer DP as the replenishment developer is denoted by DP2 so that the developer DP is referred to as the replenishment developer DP2. Note that the initial developer DP1 corresponds to a “first developer”, and the replenishment developer DP2 corresponds to a “second developer”.

When starting to use the developing device 3, the initial developer DP1 is already stored in the developing device 3 (specifically, inside the development casing 30). The initial developer DP1 is stored inside the development casing 30 when the image forming apparatus PR is shipped (before a user uses the image forming apparatus PR). In other words, when starting to use the developing device 3, the developer currently in use is only the initial developer DP1. When starting to use the developing device 3, the replenishment developer DP2 is stored in the container 41, and does not exist inside the development casing 30. This state is illustrated in FIG. 2.

While the image forming apparatus PR continues the print job, the replenishment developer DP2 is replenished into the development casing 30, while the developer currently in use is discharged from the inside of the development casing 30. In this way, inside the development casing 30, the initial developer DP1 in the developer currently in use is gradually replaced by the replenishment developer DP2. In other words, the initial developer DP1 and the replenishment developer DP2 are mixed as the developer currently in use.

Note that the image forming apparatus PR includes a controller unit CON (see FIG. 1). The developing device 3 is equipped with a T/C sensor. The T/C sensor is connected to the controller unit CON. The T/C sensor detects a mixing ratio between the toner and the carrier in the developer currently in use. On the basis of an output of the T/C sensor, the controller unit CON controls replenishment of the replenishment developer from the replenishment unit 4 to the developing device 3. In other words, the controller unit CON controls the replenishment member 42 (to rotate or stop the screw shaft).

The T/C sensor is a magnetic permeability sensor and outputs a value corresponding to a magnetic permeability of the developer currently in use. As the ratio of the carrier in the developer currently in use is higher, the magnetic permeability of the developer currently in use is higher. Utilizing this fact, the mixing ratio between the toner and the carrier in the developer currently in use is detected. Further, a toner remaining amount in the developer currently in use can be detected from the detected mixing ratio.

### <3. Developer>

Hereinafter, with reference to FIG. 3, the developer DP of this embodiment is described. The initial developer DP1 and the replenishment developer DP2 are each the developer DP. The developer set DS includes the initial developer DP1 and the replenishment developer DP2.

The developer DP contains the toner and the carrier. The toner of the developer DP contains the toner particles 1, and the carrier of the developer DP contains the carrier particles 2. The toner is an aggregate of toner particles 1, and the carrier is an aggregate of carrier particles 2. FIG. 3 schematically illustrates the single toner particle 1 and the single carrier particle 2.

Note that the initial developer DP1 and the replenishment developer DP2 may have the same component, mixing ratio between the toner and the carrier, production method, and the like. Alternatively, at least a part of the components, the mixing ratio between the toner and the carrier, the production method, and the like may be different between the initial developer DP1 and the replenishment developer DP2.

For instance, the initial developer DP1 and the replenishment developer DP2 have the same toner. The carriers of the initial developer DP1 and the replenishment developer DP2 are the same except for the hardness. The content of the carrier with respect to the toner of the initial developer DP1, which is stored in the development casing 30 when starting to use the developing device 3, is different from the content of the carrier with respect to the toner of the replenishment developer DP2, which is stored in a new container 41.

### <3-1. Toner>

The toner particle 1 has a toner mother particle 11. The toner mother particle 11 is, for example, a non-encapsulated toner mother particle without a shell layer. The toner mother particle 11 may be an encapsulated toner mother particle in which a toner core is coated with a shell layer.

The toner mother particle 11 contains binder resin, for example. As the binder resin, a thermoplastic resin such as polyester resin may be used. The toner mother particle 11 may contain a coloring agent, a charge control agent, a mold release agent, and the like.

The toner particle 1 has external additive particles 12. The external additive particles 12 adhere to the surface of the toner mother particle 11. As the external additive particles 12, silica particles, aluminum oxide particles, or the like may be used. In addition, if necessary, resin particles, magnesium oxide particles, zinc oxide particles, or the like may be used as the external additive particles 12.

In the toner particle 1, the contained amount of the silica particles is preferably 0.1 pts. mass or more and 10.0 pts. mass or less, and more preferably 0.4 pts. mass or more and 3.0 pts. mass or less, with respect to 100.0 pts. mass of toner mother particle 11. In addition, the mean primary particle diameter of the silica particle is preferably 10 nm or more and 30 nm or less, and more preferably 15 nm or more and 25 nm or less. The silica particle may be surface treated.

The contained amount of the aluminum oxide particles in the toner particle 1 is preferably 0.05 pts. mass or more and 3.0 pts. mass or less, and more preferably 0.3 pts. mass or more and 1.5 pts. mass or less, with respect to 100.0 pts. mass of toner mother particle 11. In addition, the mean primary particle diameter of the aluminum oxide particle is preferably 200 nm or more and 600 nm or less, and more preferably 300 nm or more and 500 nm or less.

Note that the mean primary particle diameter in this specification is a mean value of equivalent circle diameters of primary particles measured using a scanning electron microscope (a Heywood diameter: a diameter of a circle having the same area as a projected area of the primary particle). The mean primary particle diameter is, for example, a mean value of equivalent circle diameters of 100 primary particles. For measuring the mean primary particle diameter, a field emission type scanning electron microscope (“JSM-7600F” manufactured by Japan Electron Optics Laboratory Co., Ltd.) can be used.

### <3-2. Carrier>

The carrier particle 2 has a carrier core 21. The carrier core 21 contains magnetic material. As the magnetic material, it is possible to use a metal oxide such as ferrite, magnetite, or maghemite. Note that the ferrite has high flowability and chemical stability tendency. For this reason, it is preferred that the carrier core 21 contain ferrite. As an example of the ferrite, there is Ba ferrite, Mn ferrite, Mn—Zn ferrite, Ni—Zn ferrite, Mn—Mg ferrite, Ca—Mg ferrite, Li ferrite, and Cu—Zn ferrite. The shape of the carrier core 21 is not particularly limited, and it may be an irregular shape or a spherical shape.

The carrier core 21 has a saturation magnetization of 65 emu/g or more and 90 emu/g or less. Note that in this specification, the saturation magnetization is a value measured using a sensitive vibrating sample magnetometer (“VSM-P7” manufactured by Toei Industry Co., Ltd.) under the condition of an external magnetic field of 3,000 (Oe). If the carrier core 21 contains Mn ferrite, there is a tendency that as the content of Mn is higher, the saturation magnetization of the carrier core 21 is lower. If the carrier core 21 contains Mn—Mg ferrite, there is a tendency that as the content of Mg is higher, the saturation magnetization of the carrier core 21 is lower.

Here, if the developer currently in use stored in the developing device 3 has a low saturation magnetization of the carrier, carrier development occurs in which the carrier adheres to the photosensitive drum 5, and image quality is lowered. In addition, it is difficult to produce the carrier having a saturation magnetization more than 90 emu/g. For this reason, it is preferred that the carrier (i.e., the carrier cores 21) in the developer currently in use have a saturation magnetization of 65 emu/g or more and 90 emu/g or less.

The carrier particle 2 has a coat layer 22. The coat layer 22 coats the surface of the carrier core 21. For instance, the entire surface of the carrier core 21 is coated with the coat layer 22. The coat layer 22 is made of silicone resin. In other words, the coat layer 22 contains silicone resin as a main component (a main component of the coat layer 22 in mass base is silicone resin). The constituent resin of the coat layer 22 may consist essentially of silicone resin, or in another embodiment, may contain other resins in addition to the silicone resin. In addition, the constituent material of the coat layer 22 may contain a fluorocarbon resin.

As a preferred example of the silicone resin, there is silicone resin having a methyl group, and epoxy modified silicone resin. An example of the silicone resin having a methyl group is a silicone resin that has a methyl group but does not have a phenyl group. Another example of the silicone resin having a methyl group is a silicone resin that has a methyl group and a phenyl group.

The coat layer 22 contains barium titanate particles. The contained amount of the barium titanate particles in the coat layer 22 is 2 pts. mass or more and 47 pts. mass or less, and preferably 3 pts. mass or more and 35 pts. mass or less, and more preferably 10 pts. mass or more and 25 pts. mass or less, with respect to 100 pts. mass of the silicone resin. The mean primary particle diameter of the barium titanate particle is 100 nm or more and 500 nm or less, and preferably 150 nm or more and 450 nm or less, and more preferably 250 nm or more and 350 nm or less.

In addition, the coat layer 22 contains carbon black particles. The contained amount of the carbon black particles is 4 pts. mass or less with respect to 100 pts. mass of the silicone resin. The mean primary particle diameter of the carbon black particle is 10 nm or more and 80 nm or less, and preferably 30 nm or more and 45 nm or less.

Because the coat layer 22 contains the carbon black particles, charges move smoothly from the carrier particles 2 to the toner particles 1, and hence the toner particles 1 can be charged to a desired charge amount. In this way, an image having a desired image density and little fogging can be formed.

### <4. Carrier Resistance>

Hereinafter, a carrier resistance of the developer DP is described. Note that the initial developer DP1 and the replenishment developer DP2 have the same carrier resistance (though there is a difference due to measurement accuracy).

The developer DP is carried on the developer carrying surface 31S and passes through between the developer carrying surface 31S and the distal end 320 of the regulating blade 32 (i.e., the regulation gap). Note that the constitutional material of the regulating blade 32 is a magnetic material. In this structure, if no measure is taken, a high saturation magnetization of the carrier of the developer DP causes a stress on the developer DP at the regulation gap, and hence the carrier is deteriorated (e.g., a toner component adheres to the carrier). If the carrier of the developer DP is deteriorated, toner chargeability is deteriorated due to the characteristic change of the carrier, which causes occurrence of fogging in which the toner is adhered to a non-image area of the photosensitive drum 5 (in other words, fogging in which the toner is adhered to a blank area of the sheet S). In other words, image quality is deteriorated.

Therefore, in this embodiment, the carrier of the developer DP is made to have a high resistance. Specifically, when the carrier resistance is R (Ω), the saturation magnetization of the carrier is H (emu/g), then the carrier resistance of the developer DP is controlled to satisfy the following inequality (1).

$$14 > {log}_{10} R > 0.1 \; 35 H \qquad ( 1 )$$

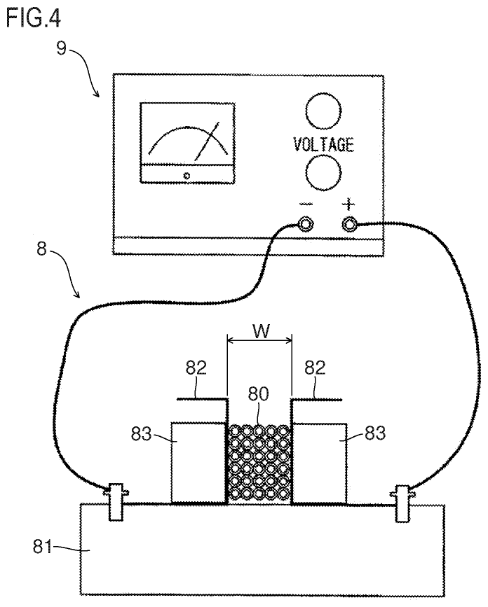

Note that in this embodiment, a resistance determined on the basis of the measurement result by a bridge method is the carrier resistance (R in the above inequality (1)). Specifically, in measurement of the carrier resistance, as illustrated in FIG. 4, a bridge type resistance measuring device 8 and a super megohmmeter 9 (“SM-8220” manufactured by HIOKI E.E. Corporation) are used. The bridge type resistance measuring device 8 has a pair of electrode plates 82 fixed on a top surface of a substrate 81 made of acrylic resin. The pair of electrode plates 82 are disposed to face each other with a space W of 1 mm. Surfaces of the pair of electrode plates 82 face each other. A magnet 83 of 1,000 gauss is disposed on each back side of the pair of electrode plates 82. The facing side of each magnet 83 has an area of 3 cm². In this way, a magnetic field is formed between the pair of electrode plates 82.

A carrier sample 80 is set between the pair of electrode plates 82. The amount of the set carrier sample 80 is 0.2 g. The carrier sample 80 is filled between the pair of electrode plates 82, so as to have a chain structure along magnetic field lines. In this state, a DC voltage of 1,000 V (an electric field of 1×10⁶ V/m) is applied between the terminals, and ten seconds later the resistance value is read by the super megohmmeter 9, and the read value (unit: Ω) is the carrier resistance (R in the above equation (1)).

In this embodiment, the carrier resistance of the developer DP is controlled so as to satisfy the above inequality (1). Because the above inequality (1) is satisfied, if the saturation magnetization of the carrier (H) is high, the carrier resistance (R) is made to be high, and hence deterioration of the carrier due to the stress on the carrier at the regulation gap (deterioration due to adhesion of a toner component to the carrier) is suppressed. In this way, deterioration of toner chargeability due to the deterioration of the carrier can be suppressed. In other words, the occurrence of fogging can be suppressed. If the carrier is not deteriorated, it is possible to suppress deterioration of image quality for a long period.

In addition, in this embodiment, because deterioration of the carrier in the developer DP is suppressed, the contained amount of the carrier contained in the replenishment developer DP2 in the container 41 can be reduced. Specifically, the contained amount of the carrier contained in the replenishment developer DP2 in the container 41 is 10 pts. mass or less with respect to 100 pts. mass of the toner. In this way, the running cost can be reduced.

Note that in this embodiment, because the coat layer 22 is made of silicone resin, it is possible to obtain the carrier having high durability. In addition, from the viewpoint of PFAS regulations in recent years, it is preferred to use silicone resin as the constituent material of the coat layer 22.

### <5. Confirmation Experiment>

Hereinafter, an experiment is described, which was performed for checking effects of this embodiment.

In the confirmation experiment, the developer set (the initial developer and the replenishment developer) was produced and used for printing, and states of printed images were checked. As the evaluation machine, an image forming apparatus (Taskalfa3554ci) manufactured by KYOCERA Document Solutions Inc. was used.

### <5-1. Preparation of Toner>

The toner to be used for the confirmation experiment was prepared by the following method.

### <5-1-1. Synthesis of Amorphous Polyester Resin>

A reaction container, equipped with a thermometer (thermocouple), a dewatering conduit, a nitrogen gas introduction conduit, and a stirring device (stirring blade), was set in an oil bath. Then, 1,575 g of bisphenol A propylene oxide additive (BPA-PO), 163 g of bisphenol A ethylene oxide additive (BPA-EO), 377 g of fumaric acid, and 4 g of catalyst (dibutyltin oxide) were put into the reaction container.

After creating a nitrogen atmosphere in the reaction container, the temperature inside the reaction container was raised to 220 degrees Celsius while stirring the contents. Under the conditions of the nitrogen atmosphere and the temperature of 220 degrees Celsius, polymerization reaction of the contents in the reaction container was performed for 8 hours while removing by-product water. Next, the pressure inside the reaction container is reduced, and under the conditions of the reduced pressure atmosphere (pressure: 7,999 Pa) and the temperature of 220 degrees Celsius, the polymerization reaction of the contents in the reaction container was performed for more 1 hour. In addition, the temperature inside the reaction container was reduced to 210 degrees Celsius, and then 336 g of trimellitic anhydride was added into the reaction container. Then, under the conditions of the reduced pressure atmosphere (pressure: 7,999 Pa) and the temperature of 210 degrees Celsius, reaction of the contents in the reaction container was performed. After that, the reaction product was taken out from the reaction container and was cooled, and hence the amorphous polyester resin having the following physical properties was obtained. Note that the polyester resin obtained in this way did not clearly show its endothermic peak in the endothermic curve measured using a differential scanning calorimeter, and its clear melting point was not able to be measured, and thus it was determined to be amorphous.
softening point (Tm):100 degrees Celsius
glass transition point (Tg):50 degrees Celsius
mass average molecular weight (Mw):30,000
acid value: 15 mgKOH/g
hydroxyl value: 30 mgKOH/g

### <5-1-2. Preparation of Toner Mother Particles>

Using an FM mixer (“FM-10B” manufactured by Nippon Coke & Engineering Co., Ltd.), 100 pts. mass of binder resin, 4 pts. mass of coloring agent, 1 pts. mass of charge control agent, and 5 pts. mass of mold release agent were mixed, so that the mixture was obtained. As the binder resin, the amorphous polyester resin described above was used. As the coloring agent, copper phthalocyanine blue pigment (C.I. Pigment Blue 15:3) was used. As the charge control agent, quaternary ammonium salt (“BONTRON (registered trademark) P-51” manufactured by Orient Chemical Industries Co., Ltd.) was used. As the mold release agent, carnauba wax (“Special Carnauba Wax 1st” manufactured by S. KATO & CO.) was used.

Next, using a twin-screw extruder (“PCM-30 type” manufactured by Ikegai Co., Ltd.), the mixture was melted and kneaded, so that the melted and kneaded material was obtained. In addition, using a mechanical pulverizer (“Turbo Mill” manufactured by Freund-Turbo Corporation), the melted and kneaded material was pulverized, so that the pulverized material was obtained. Then, using a classifier (“Elbow Jet” manufactured by Nittetsu Mining Co., Ltd.), the pulverized material was classified. In this way, powder-like toner mother particles having a volume median diameter of 6.8 μm were obtained. Note that the volume median diameter (D50) is a median diameter measured using a laser diffraction/scattering type particle size distribution measurement device (“LA-950” manufactured by HORIBA, Ltd.).

### <5-1-3. External Addition to Toner Mother Particles>

Using the FM mixer (“FM-10B” manufactured by Nippon Coke & Engineering Co., Ltd.), 100.0 pts. mass of the toner mother particle described above, 1.0 pts. mass of the silica particles (mean primary particle diameter: 20 nm), and 0.75 pts. mass of aluminum oxide particles (“AEROXIDE (registered trademark) Alu C805” manufactured by Nippon Aerosil Co., Ltd., BET specific surface area: 75 to 105 m²/g) were mixed for 5 minutes under the condition of 4,000 rpm, so that the mixture was obtained. Note that the mean primary particle diameter of the aluminum oxide particles is more than 300 nm. Then, using a sieve of 200 mesh (aperture of 75 μm), the mixture was sieved, and the toner shown in Table 1 was obtained. In the following description, the toner is denoted by “T”.

TABLE 1
toner (T)

| mother | external additive particle | |
|---|---|---|
| particle | alumina particle | silica particle |

| pts. mass | pts. mass | pts. mass | diameter (nm) |
|---|---|---|---|
| 100 | 0.75 | 1 | 20 |

### <5-2. Preparation of Carrier>

The carrier to be used for the confirmation experiment was prepared by the following method.

### <5-2-1. Preparation of Coating Liquid>

Coat resin solution, the barium titanate particles, the carbon black particles, and toluene were put into a stainless steel container. Then, using a homogenizer, the contents in the stainless steel container were mixed, so that the coating liquid was obtained. As the barium titanate particles, “BT-01” manufactured by Sakai Chemical Industry Co., Ltd. (mean primary particle diameter: 304 nm) was used. As the carbon black particle, “Ketjenblack (registered trademark) EC300J” manufactured by LION SPECIALTY CHEMICALS CO., Ltd. (mean primary particle diameter: 39.5 nm), which is conductive carbon black, was used.

### <5-2-2. Preparation of Carrier Particles>

Using a fluid bed coating machine (“FD-MP-01 D type” manufactured by Powrex Corporation), 5,000 g of the carrier cores were allowed to flow, while the coating liquid was sprayed to the carrier cores. In this way, the carrier cores coated with the coating liquid were obtained. In this case, as the carrier cores, manganese ferrite cores (manufactured by DOWA IP Creation Co., Ltd., volume median diameter: 40 μm) were used. In addition, the amount of the coating liquid input to the fluid bed coating machine was adjusted, so that the mass of the coat layer (the layer obtained by heating the coating liquid) became 15 g with respect to 1,000 g of the carrier core. Next, using an electric furnace, the carrier cores coated with the coating liquid were fired for 1 hour, so that the coat layer was formed on the surface of the carrier core. In this way, the carrier particles were obtained. Note that the hardness of the coat layer can be changed by adjusting firing conditions (firing temperature, firing time period, and the like) when forming the coat layer.

Here, in the confirmation experiment, carriers C1 to C8 were used. Characteristics of the carriers C1 to C8 are shown in Table 2. Note that resistances of the carriers C1 to C8 shown in Table 2 (values of “R”) are values obtained from the result of the measurement by the method illustrated in FIG. 4.

TABLE 2

| carrier | | | | evaluation | |
|---|---|---|---|---|---|
| | coat | saturation | | stand for | stand for |
| type | resin | magnetization (emu/g) | log₁₀R | one day | three days |
| C1 | silicone | 80 | 13.4 | A | A |
| C2 | FEP/PI | 80 | 11.5 | A | B |
| C3 | silicone | 70 | 13.6 | A | A |
| C4 | FEP/PI | 70 | 11.5 | A | A |
| C5 | FEP/PI | 70 | 10.2 | A | B |
| C6 | FEP/PI | 65 | 10.2 | A | B |
| C7 | FEP/PI | 80 | 10.2 | C | — |
| C8 | FEP/PI | 65 | 8 | C | — |

In the carriers C1 and C3, the coat layer was made of a silicone resin. As the silicone resin, “KR-255” (solid content: methylphenyl silicone resin, solid content concentration: 50 mass %) manufactured by Shin-Etsu Chemical Co., Ltd. was used. In the carriers C2 and C4 to C8, the coat layer was made of a fluorocarbon resin (FEP) and a polyimide resin (PI).

The saturation magnetization of the carrier C1 was 80 emu/g. In addition, the value of “log₁₀R” in the above inequality (1) was 13.4 in the carrier C1.

The saturation magnetization of the carrier C2 was 80 emu/g. In addition, the value of “log₁₀R” in the above inequality (1) was 11.5 in the carrier C2.

The saturation magnetization of the carrier C3 was 70 emu/g. In addition, the value of “log₁₀R” in the above inequality (1) was 13.6 in the carrier C3.

The saturation magnetization of the carrier C4 was 70 emu/g. In addition, the value of “log₁₀R” in the above inequality (1) was 11.5 in the carrier C4.

The saturation magnetization of the carrier C5 was 70 emu/g. In addition, the value of “log₁₀R” in the above inequality (1) was 10.2 in the carrier C5.

The saturation magnetization of the carrier C6 was 65 emu/g. In addition, the value of “log₁₀R” in the above inequality (1) was 10.2 in the carrier C6.

The saturation magnetization of the carrier C7 was 80 emu/g. In addition, the value of “log₁₀R” in the above inequality (1) was 10.2 in the carrier C7.

The saturation magnetization of the carrier C8 was 65 emu/g. In addition, the value of “log₁₀R” in the above inequality (1) was 8 in the carrier C8.

### <5-3. Preparation of Developer Set>

In the confirmation experiment, first to eighth developer sets were prepared.

The mass ratio of the toner with respect to the carrier in each initial developer of the first to the eighth developer sets is 6 mass % (T/C6%). In addition, in the first to the eighth developer sets, the contained amount of the carrier contained in the replenishment developer in the replenishment container is 10 pts. mass or less with respect to 100 pts. mass of the toner. Here, a type of the carrier (at least one of the coat resin, the saturation magnetization, and the resistance) is different among the first to the eighth developer sets. In each of the first to the eighth developer sets, the same carrier was used for the initial developer and the replenishment developer.

In of the first developer set, the developer in which the toner T and the carrier C1 are mixed was prepared as each of the initial developer and the replenishment developer.

In the second developer set, the developer in which the toner T and the carrier C2 are mixed was prepared as each of the initial developer and the replenishment developer.

In the third developer set, the developer in which the toner T and the carrier C3 are mixed was prepared as each of the initial developer and the replenishment developer.

In the fourth developer set, the developer in which the toner T and the carrier C4 are mixed was prepared as each of the initial developer and the replenishment developer.

In the fifth developer set, the developer in which the toner T and the carrier C5 are mixed was prepared as each of the initial developer and the replenishment developer.

In the sixth developer set, the developer in which the toner T and the carrier C6 are mixed was prepared as each of the initial developer and the replenishment developer.

In the seventh developer set, the developer in which the toner T and the carrier C7 are mixed was prepared as each of the initial developer and the replenishment developer.

In the eighth developer set, the developer in which the toner T and the carrier C8 are mixed was prepared as each of the initial developer and the replenishment developer.

### <5-4. Evaluation>

In the confirmation experiment 1, for each of the first to the eighth developer sets, the initial developer was set in the developing device (inside the development casing) of the evaluation machine, while the replenishment developer was set in the replenishment unit (container) of the evaluation machine. Then, in this state, the evaluation machine was left at a temperature of 32 degrees Celsius and a humidity of 85% RH (under HH environment) for one day. After that, an image (a solid patch image) was printed continuously on 100,000 sheets.

In the confirmation experiment 2, for each of the first to the sixth developer sets, the initial developer was set in the developing device (inside the development casing) of the evaluation machine, while the replenishment developer was set in the replenishment unit (container) of the evaluation machine. Then, in this state, the evaluation machine was left at a temperature of 32 degrees Celsius and a humidity of 85% RH (under HH environment) for three days. After that, an image (a solid patch image) was printed continuously on 100,000 sheets.

After the confirmation experiment, using a white color photometer (“TC-6DS” manufactured by Tokyo Denshoku Ltd.), an image density (D) of a blank area in each printed sheet was measured. In addition, a reflection density (Do) of an unprinted sheet was measured, so as to determine a fogging density (=D-Do). Then, the evaluation was performed by the following criteria.
A (no problem): The fogging density is 0.01 or less.
B (no problem): The fogging density is more than 0.01 and 0.015 or less.
C (has a problem): The fogging density is more than 0.015.

Results of the confirmation experiment are shown in the above Table 2. The “stand for one day” in Table 2 is the result of the confirmation experiment 1. The “stand for three days” in Table 2 is the result of the confirmation experiment 2.

As shown in the above Table 2, in the printing using the developer containing either of the carriers C1 to C6, the fogging density was a level having no problem. In particular, in the carrier C1, C3, and C4, each result of the “stand for one day” and the “stand for three days” was better, in which the fogging density was 0.01 or less.

On the other hand, in the printing using the developer containing either the carrier C7 or C8, the fogging density was more than 0.015, which was a level having a problem. Note that, for the developer containing either the carrier C7 or C8, only the printing of the confirmation experiment 1 was performed. For either the carrier C7 or C8, it is conceivable that the fogging density will be more than 0.015 also if the confirmation experiment 2 is performed.

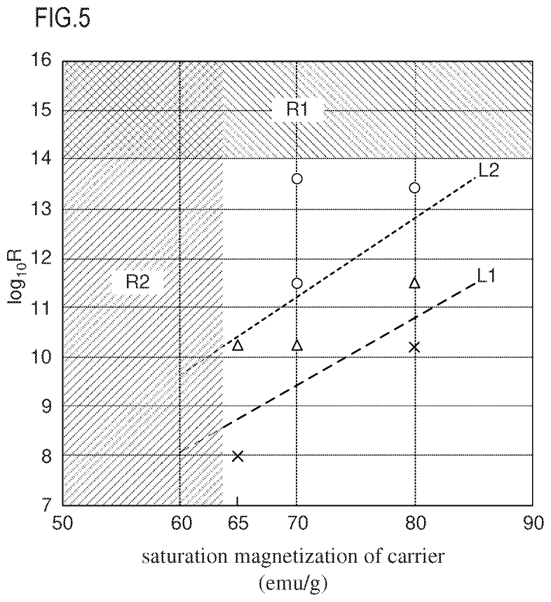

In addition, the results of the experiment were plotted in a graph, in which the vertical axis represents “log₁₀R” in the above inequality (1) while the horizontal axis represents the saturation magnetization (emu/g) of the carrier, as illustrated in FIG. 5. In the graph illustrated in FIG. 5, a circle mark indicates the evaluation A, a triangle mark indicates the evaluation B, and an x mark indicates the evaluation C. There are three circle marks, which correspond to the carriers C1, C3, and C4, respectively. There are three triangle marks, which correspond to the carrier C2, C5, and C6, respectively. There are two x marks, which correspond to the carriers C7 and C8, respectively.

In the graph of FIG. 5, the boundary between the range where the evaluation is “B” and the range where the evaluation is “C” can be indicated by a straight line L1. The straight line L1 can be expressed by “log₁₀R=0.135H”. In addition, the boundary between the range where the evaluation is “A” and the range where the evaluation is “B” can be indicated by a straight line L2. The straight line L2 can be expressed by “log₁₀R=0.16H”.

According to the graph of FIG. 5, it can be said that when the value of “log₁₀R” becomes the value of “0.135H” or less, the fogging density becomes a level having a problem.

For instance, in the carrier C7 where the evaluation was “C” in the confirmation experiment 1 (stand for one day), the value of “log₁₀R” is 10.2, and the value of “0.135H” is 10.8. In the carrier C8 where the evaluation was “C”, the value of “log₁₀R” is 8, and the value of “0.135H” is 8.775. In the carrier C7 and in the carrier C8, the value of “log₁₀R” is the value of “0.135H” or less.

On the other hand, according to the graph of FIG. 5, the value of “log₁₀R” is more than the value of “0.135H”, and hence it can be said that the fogging density is a level having no problem.

For instance, in the carrier C2 where the evaluation was “B” in the confirmation experiment 2 (stand for three days), the value of “log₁₀R” is 11.5, and the value of “0.135H” is 10.8. In the carrier C5 where the evaluation was “B”, the value of “log₁₀R” is 10.2, and the value of “0.135H” is 9.45. In the carrier C6 where the evaluation was “B”, the value of “log₁₀R” is 10.2, and the value of “0.135H” is 8.775. In the carriers C2, C5, and C6, the value of “log₁₀R” is more than the value of “0.135H”. In other words, log₁₀R>0.135H is satisfied.

In addition, in the carrier C1 where the evaluation was “A” in the confirmation experiment 2 (stand for three days), the value of “log₁₀R” is 13.5, and the value of “0.135H” is 10.8. In the carrier C3 where the evaluation was “A”, the value of “log₁₀R” is 13.6, and the value of “0.135H” is 9.45. In the carrier C4 where the evaluation was “A”, the value of “log₁₀R” is 11.5, and the value of “0.135H” is 9.45. In the carriers C1, C3, and C4, the value of “log₁₀R” is more than the value of “0.135H”. In other words, log₁₀R>0.135H is satisfied.

Note that, if the value of “log₁₀R” is 14 or more, a development ghost tends to occur, in which a trace of printing before one turn of the developing roller appears on an image. In the graph of FIG. 5, the area where a development ghost tends to occur is shown by hatching, and the area is denoted by R1. If the saturation magnetization of the carrier is 64 emu/g or less, the carrier development tends to occur, in which the carrier adheres to the photosensitive drum. In the graph of FIG. 5, the area where the carrier development tends to occur is shown by hatching, and the area is denoted by R2.

Therefore, it can be said that it is preferable to satisfy the above inequality (1) in order to suppress occurrence of fogging. Each of the carriers C1 to C6 satisfies the above inequality (1).

Here, in the confirmation experiment 2 (stand for three days), the evaluations of the carrier C1, C3, and C4 were each “A”. In the carrier C1, the value of “0.16H” is 12.8. In the carriers C3 and C4, the value of “0.16H” is 11.2. In the carriers C1, C3, and C4, the value of “log₁₀R” is more than the value of “0.16H”.

In this way, it can be said that it is more preferable to satisfy the following inequality (2).

$$14 > {log}_{10} R > 0.16 H \qquad ( 2 )$$

When the above inequality (2) is satisfied, it is possible to further suppress occurrence of fogging. In other words, it is possible to further suppress deterioration of image quality.

The embodiment disclosed this time is merely an example in every aspect, and should not be considered as a limitation. The scope of the present disclosure is defined not by the above description of the embodiment but by the claims, and further it includes all modifications within meaning and scope equivalent to the claims.

What is claimed is:

1. A two-component developer to be used for developing an electrostatic latent image by a developing device, the developer comprising toner and carrier, wherein when a carrier resistance is R (Ω), and a saturation magnetization of the carrier is H (emu/g), then 14>log₁₀R>0.135H is satisfied.

2. The two-component developer according to claim 1, wherein 14>log₁₀R>0.16H is satisfied.

3. The two-component developer according to claim 1, wherein the saturation magnetization of the carrier is 65 emu/g or more and 90 emu/g or less.

4. The two-component developer according to claim 1, wherein
the carrier contains carrier cores coated with coat layers, and
the coat layer is made of silicone resin.

5. A developer set comprising:
a first developer stored in a developing device from beginning of use of the developing device; and
a second developer stored in a replenishment container connected to the developing device, so as to be replenished to the developing device after starting use of the developing device, wherein
the first developer and the second developer are each the two-component developer according to claim 1, and
a contained amount of carrier in the second developer in the replenishment container is 10 pts. mass or less with respect to 100 pts. mass of the toner.

6. A developing device for developing an electrostatic latent image using the two-component developer according to claim 1, the device comprising:
a developing roller supported in a rotatable manner, the developing roller rotating while carrying the two-component developer on an outer peripheral surface, so as to convey the two-component developer on the outer peripheral surface to a development position, and to supply the toner to the electrostatic latent image at the development position; and
a regulating blade made of a magnetic material, having a distal end at a position apart from the outer peripheral surface, on an upstream side of the development position in a rotation direction of the developing roller, so as to regulate a layer thickness of the two-component developer passing through between the outer peripheral surface and the distal end.

7. An image forming apparatus comprising:
the developing device according to claim 6; and
a transfer unit configured to transfer an image developed by the developing device onto a sheet.
